(19) United States
(12) Patent Application Publication
(10) Pub. No.: US 2008/0021952 A1
(43) Pub. Date: Jan. 24, 2008

(54) Data Exchange Process and Device

(76) Inventors: Alain MOLINIE, Clapiers (FR); Eric LAVIGNE, Clapiers (FR); Vincent LECLAIRE, Clapiers (FR)

Correspondence Address: YOUNG & THOMPSON, 745 SOUTH 23RD STREET, 2ND FLOOR, ARLINGTON, VA, 22202, US

(21) Appl. No.: 10/580,332

(22) PCT Filed: Feb. 1, 2006
(86) PCT No.: PCT/IB06/00187

§ 371 Date: Nov. 8, 2006

(30) Foreign Application Priority Data
Feb. 1, 2005 (FR) 0501060
Apr. 13, 2005 (FR) 0503709

(51) Int. Cl. G06F 15/16

(52) U.S. Cl. 709/203

(57) ABSTRACT

The invention concerns a method for exchanging data between appliances connected to a network, including: a step of searching (320), by at least two appliances, for at least one type of media representing at least one physical entity, directly accessible by said appliance, a step of transmitting (335), by at least one appliance having performed the searching step to at least another appliance capable of processing said type of media, a list representing media found on said appliance during the searching step, and a step of aggregating (345), by each appliance having performed the search, the lists of media found and/or received independently of the appliance where said media are located.

This invention concerns a process and a device for data exchange. It applies, in particular, to the exchange of data between different sources and broadcasters of signals in a home network, for example between a music system, a television, a computer terminal, a remote control.

Each user of audio-visual and computer material may have many data sources that represent, in different ways, the same physical entities, for example image signals or sound signals.

Thus, video cassette players, digital cameras, compact disk players, videophones, video interphones, video-surveillance systems are all able to provide data representing images, but on media and in formats so different that only a very limited exchange is possible. The user cannot therefore choose any source whatsoever and any image display means whatsoever in order to access this data.

The aim of this invention is to remedy these inconveniences.

To this end, according to a first aspect, the present invention envisages a process of data exchange between devices linked to a network, characterized in that it comprises:
a step of searching, by each of at least two devices, for at least one media type representing at least one type of physical entity, directly accessible by said device,
a step of transmitting, by each device having carried out said search step to at least one other device capable of handling said media type, a list representing media found on said device during the search step and
a step of aggregating, by each device having carried out said search step, lists of media found and/or received independent of the device where said media are located.

Thus, the user has virtual access, on each device carrying out the aggregation step, to a group of media that are available, independent of the device to which he or she has access.

Thus, the architecture is not centralized but instead is based on the availability of services on the network. Each device sends a general request to which all entities that are capable of performing the service required respond, and the operation is dynamic.

According to particular features, during the aggregation step, the aggregated lists are organized by physical entity.

Thus, sound files are put in a first category, still image files are put in a second category, animated image files are put in a third category, for example.

According to particular features, during the aggregation step, the aggregated lists are organized by media type.

Thus, compressed files are put into different categories according to the compression or coding formats that were used.

According to particular features, during the search step, media subject to a broadcast limitation or ban are not taken into account.

Thus, for example, films stored in non-volatile memory may be protected against pirated copies and remain readable only on each device reading said non-volatile memory.

According to particular features, during the aggregation step, the aggregated list comprises, for each medium, a pointer representing the localization of said medium on the network.

Thanks to these provisions, each device having carried out an aggregation step can access each medium individually.

According to particular features, during the aggregation step, the aggregated list comprises, for each medium, an interface capable of handling said medium.

Thanks to these provisions, the device performing said aggregation is able to handle each medium on the list.

According to special features, for at least one medium utilizing hypertext links, during the search step, pages accessible by the device performing the search are looked for and, during the transmission step, a list representing these pages is transmitted.

It is noted that these pages, for example pages of sites accessible on the Internet network, may be pages of sites recently visited, pages bookmarked as favorites and pages on which windows are open on the device.

According to special features, for at least one medium utilizing hypertext links, during the search step, links accessible in a page of a window opened by the device carrying out the search are looked for and, during the transmission step, a list representing these links is transmitted.

According to particular features, the process as described in brief above comprises a step of selecting, for at least one media output device, a medium represented in the aggregated list.

According to particular features, the process as described in brief above comprises a step of selecting a media output device.

Thanks to these provisions, the user can choose to display, on a television, pages that his or her personal computer accesses or photographs stored in his or her digital camera, for example, by a simple selection from the aggregated list.

According to particular features, said step of selecting a medium comprises a step of selection by a hand-held remote control.

According to particular features, during the step of selection via a hand-held remote control, optical signals and radio signals are output by said remote control.

Thanks to these provisions, several signal receivers may simultaneously receive the commands output by the hand-held remote control, even if they are optically masked.

According to particular features, in the course of the step of selection via a hand-held remote control, three-dimensional images representing devices capable of outputting at least one media type are displayed, on said remote control.

According to particular features, during the step of selection via a hand-held remote control, a request is output for each device in the remote control's range to provide a response identifying it.

According to particular features, during the step of selecting a medium, all the arrow keys and a confirmation key are utilized.

According to particular features, following the step of selecting a medium, the device giving the most direct access to the selected medium transmits said medium to the device selected to output said medium.

According to a second aspect, the present invention envisages a device for exchanging data between devices linked to a network, characterized in that it comprises, in at least two of said devices:
a means of searching for at least one media type representing at least one type of physical entity, directly accessible by said device;
a means of transmitting, by at least one other device capable of handling said media type, a list representing media found on said device during the search means and
a means of aggregating lists of media found and/or received independent of the device where said media are located.

Thus, the user has virtual access, on each device carrying out the aggregation step, to a group of media that are available, independent of the device to which he or she has access.

According to particular features, the aggregation means is adapted so that the aggregated lists are organized by physical entity.

According to particular features, the aggregation means is adapted so that the aggregated lists are organized by media type.

According to particular features, the search means is adapted to not take into account media subject to a broadcast limitation or ban.

According to particular features, the aggregation means is adapted so that the aggregated list comprises, for each medium, a pointer which represents the localization of said medium on the network.

According to particular features, the aggregation means is adapted so that the aggregated list comprises, for each medium, an interface capable of handling said medium.

According to particular features, the process as described in brief above comprises a means of selecting a medium represented in the aggregated list.

According to particular features, the device as described in brief above comprises a means of selecting a device for outputting a medium.

According to particular features, said means of selecting a medium comprises a hand-held remote control.

According to particular features, said hand-held remote control comprises an optical signal emitter and a radio signal emitter.

According to particular features, the hand-held remote control is adapted to display three-dimensional images representing devices capable of outputting at least one media type.

According to particular features, the hand-held remote control is adapted to output a request for each device in the remote control's range to provide a response identifying it.

According to particular features, at least one device is adapted so that the selection of a medium utilizes arrow keys and a confirmation key.

According to particular features, where the selection of a medium involves a medium for which the device gives the most direct access to the selected medium, the means of transmission is adapted to transmit said medium to the device selected to output said medium.

The advantages, aims and characteristics of the device that is the subject of the second aspect of the present invention being similar to those of the first aspect of the present invention, as briefly described above, they are not repeated here.

This invention also concerns a remote control process and a device. It applies, in particular, to the remote control of computer systems, multi-media systems, audio-visual systems or home automation systems, such as televisions, decoders, audio systems, computers, heating or air-conditioning systems, shutters or alarm systems.

There are remote controls already known, in the audio-visual field, which are equipped with a keyboard, possibly with a screen and an emitter of signals, usually infrared or hertzian. Some of these remote controls are called universal because they output standardized signals that may be interpreted in the same way by different remote-controlled electronic devices.

Nevertheless, these remote controls present no ability to adapt to their environment, for example, to the person using them, to equipment capable of being remotely controlled, to the media available, to their position in space, to the time or to the availability of functions for equipment utilizing a communications protocol with the remote control.

But the inventors have discovered that automatically reconfiguring a remote control according to its environment may make new services or functions possible. For example:
depending on the person using it, a remote control may limit the television channels that can be accessed or limit access to media present on a computer network and
depending on the equipment in the remote control's range, different media or different functions are proposed to the user.

The third and fourth aspects of the present invention envisage, in particular, simplifying the use of a remote control while still allowing a large number of devices to be controlled with the same remote control.

To this end, according to a third aspect, the present invention envisages a remote control configuration process, characterized in that it comprises:
a step of determining at least one environment parameter for the remote control and
a step of auto-configuring the provisioning of functions and/or media to the remote control's user.

Thanks to these provisions, the user has the configuration needed for his or her remote control according to at least one environment parameter for the remote control. For example, the environment parameter concerning the person using the remote control, the equipment capable of being remotely controlled, the media available, their position in space, the time and the availability of functions for equipment utilizing a communications protocol with the remote control.

According to particular features, in the course of the step determining at least one environment parameter for the remote control, the person using the remote control is ascertained.

According to particular features, in the course of the step determining at least one environment parameter for the remote control, the equipment capable of being remotely controlled is ascertained.

According to particular features, in the course of the step determining at least one environment parameter for the remote control, the media available are ascertained.

According to particular features, in the course of the step determining at least one environment parameter for the remote control, the position in space of the equipment capable of being remotely controlled is ascertained.

According to particular features, in the course of the step determining at least one environment parameter for the remote control, the time is ascertained.

According to particular features, in the course of the step determining at least one environment parameter for the remote control, the availability of functions for equipment utilizing a communications protocol with the remote control is ascertained.

Thanks to each of these provisions, the remote control presents optimized ergonomics and/or protection for the user.

For example, depending on the person using it and/or the time, the remote control limits the television channels that can be accessed or limits access to media present on a computer network.

For example, depending on the equipment in the remote control's range, different media or different functions are proposed to the user.

According to particular features, in the course of the step of auto-configuring the provisioning of functions or media to the remote control's user, the functions and/or the media to which access is authorized and/or available are displayed and/or activated, according to each environment parameter determined during the step of determining at least one environment parameter for the remote control.

According to a fourth aspect, the present invention envisages a device for configuring a remote control, characterized in that it comprises:
a means of determining at least one environment parameter for the remote control and
a means of auto-configuring the provisioning of functions and/or media to the remote control's user.

The advantages, aims and characteristics of the device that is the subject of the fourth aspect of the present invention being similar to those of the process that was the subject of the third aspect of the present invention, they are not repeated here.

The different aspects of the present invention are intended to be combined together, as well as their particular features which are described in brief above or in the description below, in order to realize a process of data exchange under the control of a particularly powerful remote control adaptable to different conditions of use and different user conditions.

Other advantages, aims and characteristics of the present invention will become apparent from the description that will follow, made, as an example that is in no way limiting, with reference to the drawings included in an appendix, in which:

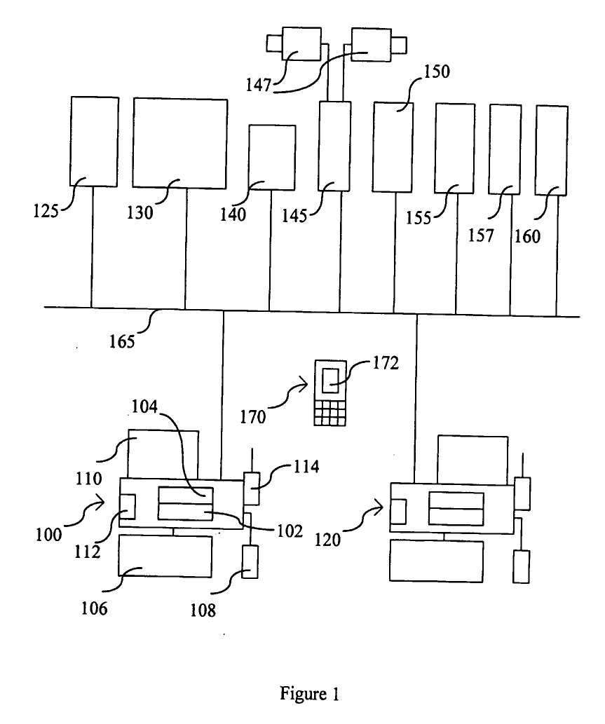

FIG. 1 represents, schematically, a particular embodiment of the device for editing images and the remote control device that are the subject of the present invention,

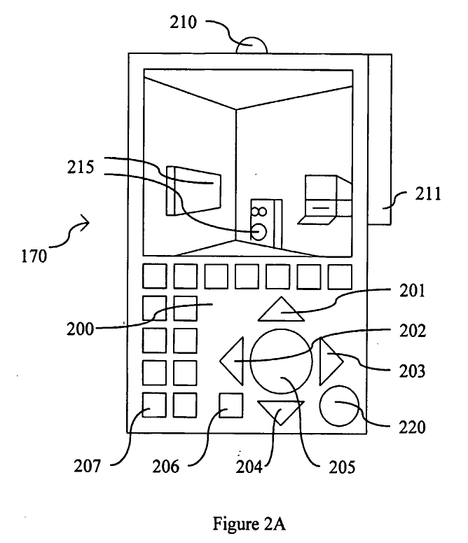

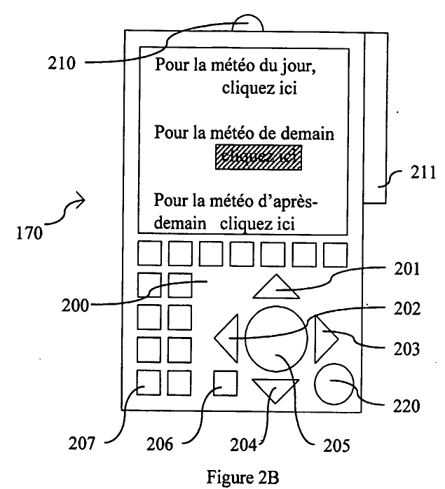

FIGS. 2A and 2B represent, schematically, a remote control and its display, for preference utilized in combination with the device illustrated in FIG. 1, during two phases of operation of this device,

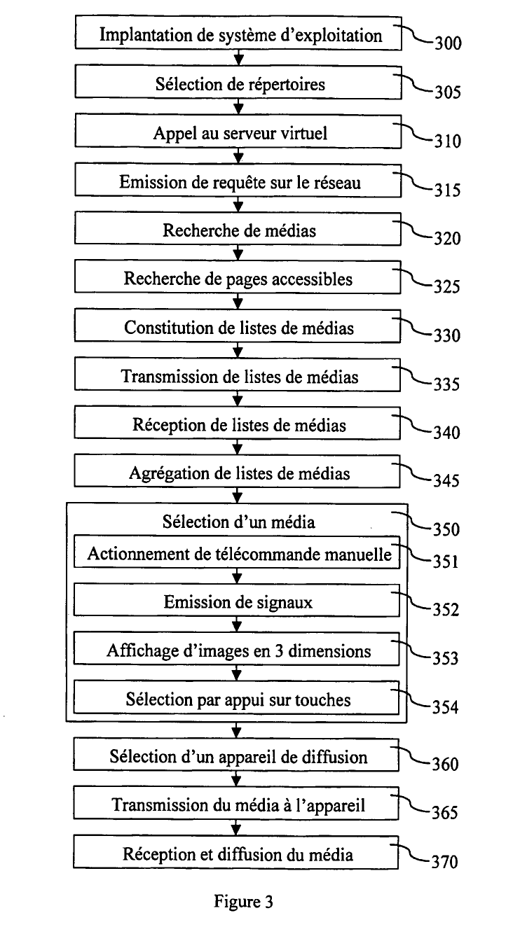

FIG. 3 represents, in the form of a logical diagram, a particular embodiment of the process for editing images that is the subject of the present invention and

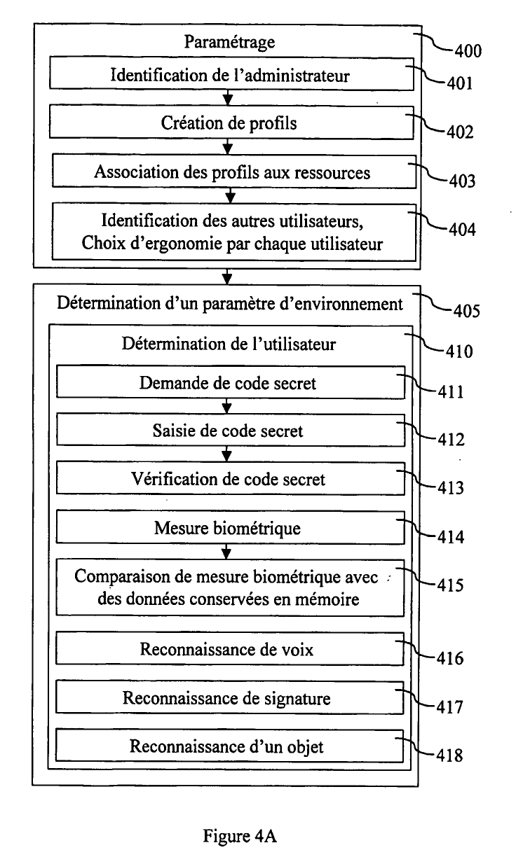

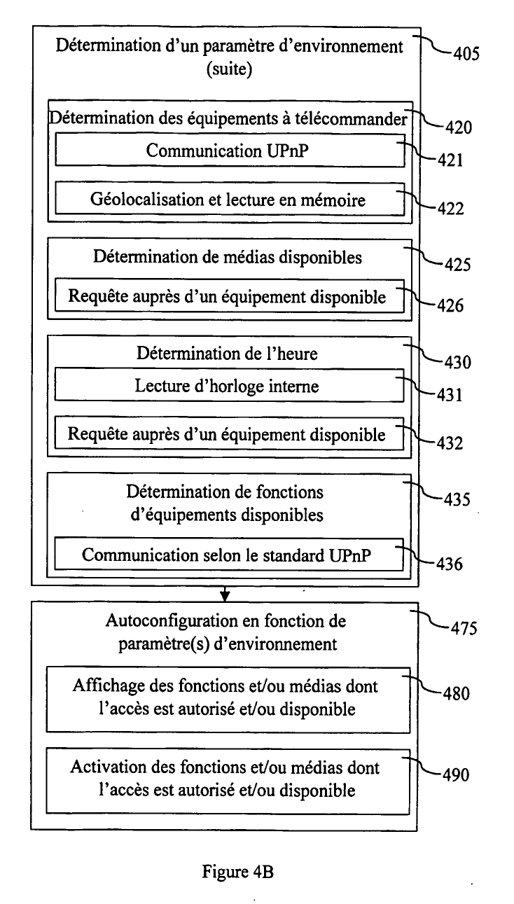

FIGS. 4A and 4B represent, in the form of a logical diagram, a particular embodiment of the remote control process that is the subject of the present invention.

Though the devices described for accessing a computer network, for example the Internet, are, in the description, described as user terminals, especially of the personal computer type, all types of devices may be utilized, for example personal digital assistants (known under the name PDA, for personal digital assistant) and telephones, in particular mobile telephones.

There can be seen, in FIG. 1, a home network comprising a user terminal 100, a user terminal 120, a server 125, a television 130, an interphone 140, a surveillance system 145 comprising video surveillance cameras 147, a home automation system 150, a music system 155, a video signal decoder 157 and a film player 160. All these devices are linked to each other by a network 165. Some of these devices are controlled by a remote control 170.

The user terminal 100, of known type, for example in the form of a personal computer (known under the name PC, for personal computer) comprises a central processing unit 102, a non-volatile memory 104, a keyboard 106, a pointing device 108, a display screen 110, a modem 112 and a radio communications peripheral 114 for the communication between the remote control 170 and the terminal 100. The user terminal 100 is adapted to utilize an Internet navigation software system and, for preference as a background task, an operating system and a software system utilizing the data exchange process that is the subject of the present invention. The operating system provides generic services that may be used by any type of application whatsoever and the software system makes appropriate use of it. For example, the operating system provides network access services, but the data that is conveyed by these services falls within the jurisdiction of the software system (the application layer).

The non-volatile memory 104 takes, for example, the form of a hard disk. The keyboard 106 is a keyboard with keys or a touch-screen, for example. The pointing device 108 takes, for example, the form of a mouse, a track-ball, a touch-pad or a touch-screen. The modem 112 may be adapted to a switched telephone network, to a broadband network, to a cable network, to a satellite network or to a terrestrial wireless network, for example.

The radio communications peripheral 114 for the communication between the remote control 170 and the terminal 100 is of a known type and utilizes, for example, a 433 MHz carrier wave and a “USB” port (acronym for Universal Serial Bus).

The user terminal 120 is similar to the user terminal 100. The components, sub-systems and software systems of the user terminal 120 are therefore not detailed here.

The signal decoder 157 is known, in the United States, under the name “set-top box”. It decodes the signals of hertzian, cable or satellite television channels.

The server 125, the television 130, the music system 155, the video signal decoder 157 and the film player 160 all have a software system utilizing the data exchange process that is the subject of the present invention. The remote control is illustrated in FIGS. 2A and 2B. The remote control 170 utilizes a special display and navigation software system, if it is equipped with a display, as is the case in FIGS. 2A and 2B.

In a variant (not shown) the interphone 140, the surveillance system 145 comprising video surveillance cameras 147 and the home automation system 150 also utilize a software system implementing the data exchange process that is the subject of the present invention.

All the devices, server 125, television 130, music system 155, video signal decoder 157, film player 160 and remote control 170, utilize UPnP standard (for Universal Plug and Play), in their communications. It is noted here that this standard makes auto-configuration possible for devices linked in a network without a complicated installation step and enables these devices to recognize each other and to inspect each other via descriptions of their functionalities.

The music system 155 is adapted to read musical media and output sound signals. The film player 160 is of the camcorder, video cassette player or optical disk reader type.

It is observed that not all the devices illustrated in FIG. 1 are essential for this invention's utilization but that, for preference, the latter utilizes at least the terminal 100 and the signal decoder 157 linked to the television 130, the terminal 100 and the signal decoder 157 being linked to each other by a electric wire or a wireless medium (not shown), for example units known under the commercial name of “video sender” (registered trademark) or “video transmitter” (registered trademark), which communicate to each other over a 2.4 GHz carrier wave.

The remote control 170 comprises a central processing unit 172 that, for example, utilizes a software system implementing the steps described with regard to FIGS. 4A and 4B.

FIG. 2A shows that the remote control 170 comprises a keyboard 200 consisting of arrow keys 201 to 204, a confirmation key 205, a return key 206 and other keys 207, an emitter/receiver of visual signals 210, for example of infra-red signals, and an emitter/receiver of radio signals 220. The remote control 170 is adapted to control all or some of the devices shown in FIG. 1 and, in particular, the television 130 and the signal decoders 157 by means of infra-red signals and the terminal 100, by means of radio signals.

Though the remote control 170 is described here in the form of a standard remote control, it may, in a variant, take the form of a personal digital assistant (known under the name PDA, for personal digital assistant) or a hand-held computer (known under the name “pocket PC”) or a mobile telephone.

Thus, the remote control 170 communicates both over a radio medium, with the user terminal 100, and over an infrared medium, with the television 130 or with the signal decoder 157, in a manner known “per se”.

By utilizing this invention, the user may have, on one auxiliary input of his television, for example auxiliary 1, one channel, a film player output 160 and, on one auxiliary input, for example auxiliary 2, access to an aggregated list of all media available and with access authorized, for this user, present on the network 165. This access is also called, in the description, “media server” and comprises access to data with authorized access stored by the devices linked to the network and to authorized data accessible through the computer network, for example Internet, via the modem 112 of the user terminal 100.

The remote control 170 thus gives access, by simplified ergonomics, to be chosen by each user, utilizing the arrow and confirmation keys, for example to an image library on the PC's hard disk or a slide show or music files or films, just like to a television channel.

It is noted that the remote control 170 also controls the sound and the pause and restart functions for outputting a medium.

The software system utilizing the data exchange process that is the subject of the present invention comprises three modules (not shown):
the “media server” module, which makes it possible for several devices to each display an aggregated list of media available on the network and with authorized access,
the “renderer” module, which utilizes the main data transmission and/or compression standards and drivers of the media available on the network, for example MP3 and divix (registered trademarks) and
the “control point” module, which makes it possible, either by using the remote control 170, or by using the user interfaces of the devices utilized, to select a medium, in an aggregated list, and a device that is going to output said medium, from among the devices linked to the network 165.

After simple “drag-n-drop” operations to inform the media server of the directories where it has to look for the media among the equipment and directories with access authorized for the user, the media server module implemented on the terminal 100 parses all the media, data files representing physical entities, for example sound and/or image, authorized and available on the terminal 100 and creates a virtual database or list in which the media are automatically indexed and organized by physical entity, for example in the following manner:
audio-visual media,
still image media,
sound media and
pages available on the computer network, for example Internet, and bookmarked by the user.

It is noted that the rights of access (known as DRM, for Digital Rights Management) may comprise refusals to aggregate (for example for all the media coming from the signal decoder 157 or through rights on the files stored by the terminal 100) for media, in which case the media server module cannot take account of media for which broadcasting is not authorized, in the list or database transmitted.

Then, the list of media is transmitted to the signal decoder 157, and to the other devices that aggregate it, according to a tree structure, first of all by physical entities represented by these media, then media by media, with the list of other media available on the network 165 that these devices may handle, for example output.

To this end, for example on the signal decoder 157, a portable server is provided for which is independent of the signal decoder's operating system and which manages the virtual database of the aggregated list of available media.

It is noted that, thanks to these features, each device linked to the network has access to identification of the media available and with access authorized, without these media having been moved. Each device capable of outputting a medium, for example the signal decoder 157, then associates to each medium in the aggregated list, an application interfacing between the format of the medium and the format of the output device to which it is associated, here, the television. For example, the following interfaces are associated with media: MP3, Divix, Codec Microsoft (registered trademark), Codec mpeg 2 (registered trademark) players. The signal decoder 157 then displays the first level of knots for the aggregated list tree structure, on the television 130.

For preference, the devices performing the aggregation of the lists or virtual databases only aggregate the media that they may output. For example, a camera does not aggregate text files. Thus, each device only displays an aggregated list of the media to which it can give access.

The remote control 170, or “control point module”, makes it possible to select, remotely, on the one hand, a device for outputting the information represented by a medium and, on the other hand, a medium to be output by said output device. According to the implementations, the user interface of this remote control 170 may be a keyboard, a pointing device, a remote control, a touch-screen. In other embodiments of the two first aspects of this invention, without user interface, this module is controlled by a background task automatically starting up a medium at a given time, for example.

In order to select the device for outputting the media, the remote control 170 first sends a request to all the devices capable of communicating with it, in accordance with UPnP standard. In response, all the devices capable of communicating with the remote control 170 send a response identifying them, which is to say indicating the functions of these devices.

When these responses have been received, the remote control 170 displays, with special ergonomics that may be selected by one or more of its users, a three-dimensional shape 215 representative of each device having responded, for example a three-dimensional image of a television with a cathode-ray tube, a three-dimensional image of a flat-screen television, a desktop computer, a portable computer, a signal decoder, a lamp, roller shutters, etc. As FIG. 2A shows, these images are organized in a virtual room resembling the inside of a house or an apartment.

This man-machine interface is adapted to its environment either through configuration by the user or else automatically (see steps 405 and 475).

To automatically adapt the representation of devices that have responded and are capable of communicating with the remote control, these devices may be geo-localized, for example through the use of a number of infrared or bluetooth (registered trademark) WIFI emitters and triangulation, after measuring the power received, the signal level or the level of CRC (Cyclic Redundancy Check) use.

In addition, this man-machine interface carries out an automatic personalization depending on the person utilizing it: an auto-configuration takes place according to the identification of the user. This identification is, for example, given by a secret code or by using a biometric sensor 220, which makes it possible to assign access limitations to restricted material for certain potential users (for example, children).

If, with the remote control 170, the user selects the media accessible via Internet, by using the right arrow of his or her remote control's keyboard in the list of types of physical entities available, he or she will see, on the output device, for example the television 130, or on the screen of his or her remote control 170, if it has one, a list of the pages of sites directly accessible.

By using the arrows 201 to 204 of the remote control's keyboard, the user selects the page in the list of pages and confirms his or her choice with the confirmation key 205.

Once the user has selected an electronic address in the aggregated list, the page corresponding to said address is displayed and the software application automatically finds all the hypertext links available on the page as well as their position in the page (in X and Y coordinate axes).

By using the remote control's keyboard arrows, the user may choose and select a link from the page (see FIG. 2B).

Thus, in certain embodiments of the data exchange process that is the subject of this invention, the user is provided with an embedded Internet navigator for environments that do not have one. Here the definition of a “navigator” used is that of an application making use of the Internet network and presenting data coming from it in a graphical form.

To this end, the device that accesses the Internet, here the terminal 100, carries out the identification of all the links present on the page and arranges them in a list which it keeps. For example, this identification is carried out by standard functions of the operating system or the navigator, which the software calls up. Other techniques may be utilized, such as analyzing HTML source code in order to detect the tags signaling the existence of links in the page.

Each link is then identified by its physical position in the page displayed and the relationships between the physical positions of the links are mapped with the remote control's arrow keys in a two-dimensional table in which each cell is occupied, at most, by one link.

For example, starting from a first link, the other link which is to the right of the first link at an angle in the range [+45°, −45°[ and the closest of the first link is assigned to the right cell of the table, with regard to the cell corresponding to the first link.

Starting from the first link represented in a given cell of this table, when the user presses the right arrow of the remote control's keyboard, it causes the link that is in the cell of the table to the right of the cell assigned to the first link to be highlighted.

The first link highlighted is the first link of the list when the page is first displayed. Thus, links are highlighted starting with the link that is the highest to the left, followed, according to a search algorithm, by the “closest” link according to the navigation key or arrow 201 to 204 pressed.

Once the relevant link is highlighted, the user presses the confirmation key 205 to select the link, just as if he or she had clicked on it with the pointing device 108.

To exit the page, the user presses the return key 206 on his or her remote control 170.

The “Renderer” module, which outputs the media content on a device or equipment chosen by the user, utilizes the principles of exchange between peers, called “peer-to-peer” exchanges in English, in order to exchange media files. It is noted that, in standard architectures, the exchanges between two clients are managed by a server during the whole length of the communication. In the “peer-to-peer” principle, each of the ends knows the other, either through a prior request over a server, which only has this role at the beginning of the session, or because the users have come to an agreement. Each of the two machines is client and server and they have no need of outside help to communicate.

Once the selection by physical entity and media type has been done, the user is shown lists of media organized by centers of interest or by genre. It is noted that, among the properties of the files there are descriptions, known as “tags”. These tags represent, for example, the genre for a piece of music, for example jazz, rock, classical, etc. The user may edit some of these descriptions in order to indicate his or her centers of interest.

In the same way, the list may be organized by date, by artist, alphabetically, etc. It is noted that the organization may utilize the result from automatic systems analyzing groups of files, for example musical files, in order to assign a genre to each file, for example depending on rhythms, instruments, etc.

The organization may also utilize media usage data, for example by listing first the media that the remote control's user has used most or has used the most recently.

It is noted that, in the absence of descriptive data, the file name is used.

Where there is duplication (two media having the same descriptive data), it is possible, for example, to leave the duplication in the aggregated list or to give priority to the local medium and remove each remote duplicate.

On suitable equipment, the software may manage a number of input and output flows, a number of input devices (sources) and output devices (renderers) and memorize the content on local or remote hard disks.

The selected media sources are referenced and indexed in a media database. This content and the related information are made available to the world outside each device in the network by means of UPnP requests. Every UPnP-compatible application may connect itself to the media server module and ask for any of this media server module's content.

The media server module provides a database manager by default, even if it could utilize other pre-existing database managers.

The media renderer module interfaces between the media files and the end output device.

It is noted that a thin operating system is sufficient to utilize the data exchange process that is the subject of the present invention, in particular on devices that are not computers, for example the signal decoder 157.

In a variant, the remote control comprises a means of detecting orientation. For example, this means of detecting orientation comprises at least one gyroscope, the relative movements of the remote control casing with relation to each gyroscope, whose orientation in space is noticeably constant, being measured and taken into account in order to produce a means of pointing whose functions are similar to those of a mouse, for example.

If, as shown in FIGS. 2A and 2B, the graphical user interface (in English, GUI for graphical user interface) is located on the remote control, the orientation signals coming from each gyroscope are utilized by the remote control's circuits in order to move a cursor in this interface. If, in a variant, the graphical user interface is located on a screen external to the remote control, for example a television screen or computer screen, the cursor position signals are transmitted remotely, for preference, in the form of hertzian signals to the radio communication peripheral 114 (see FIG. 1). The remote control also comprises at least one key whose functions are similar to those of a mouse button. It is understood that such a remote control makes it possible to start, stop, and pause reading media and to perform other functions, by means of menus or icons, for example.

FIG. 3 shows a step 300 of an implementation of the thin operating system on various devices capable of utilizing the data exchange process that is the subject of the present invention.

The operating system that is installed on each device is architectured in layers according to an abstract architecture. In this architecture, the applications are always “control points” in the broad sense of the term. Whether media or home automation applications, the applications are the software elements that are going to make use of the services available on the network, either in a basic way (direct command by the user) or in a evolved way (programmed reactions to events, pre-programmed actions, etc) with or without user interface as already presented earlier.

The platform comprises JAVA-compatible (registered trademark) sub-systems constituting a thin, quick virtual machine that is adapted to respond to the requirements of the embedded software markets. The virtual machine is Java-compatible at the bytecode and file format level. However, not all the Java base classes are available.

For utilization on an already installed network comprising a terminal and a personal digital assistant, the additional elements comprise software systems for computer terminals (media server, media renderer and UPnP standard support), software systems for personal assistants (Java virtual machine, compiled to be executed in the target environment, UPnP standard support and the application itself, Java code designed to be executed on this virtual machine).

The software systems have been designed to be independent of pre-existing platforms and make extensive use of abstract layers and virtual operating environments. In the operating system field, there are programming interface (API) standards making it possible for a software system that respects the specifications of these standards to be executed on any of these systems whatsoever. The POSIX standard (registered trademark, acronym for Portable Operating System Interface for Unix), for example, is implemented by some Unix (registered trademark), Linux (registered trademark), partially by Windows (registered trademark) and OS/2 (registered trademark); thus, by providing code for using these standards, they are made de facto compatible with the existing platforms respecting said standard.

The operating system utilized is, for example, POSIX-compatible. This highly compatible environment may be replaced by an office computer operating system (Windows or Linux, registered trademarks).

For example, on the signal decoder 157, a portable server is provided for which is independent of the signal decoder's operating system and which manages the virtual database of the aggregated list of available media.

During a step 305, the user performs a selection of directories on each device or, by default, all the directories are selected. To perform this selection, the user performs simple “drag-n-drop” operations in order to inform the media server of the directories where it must search for the media.

During a step 310, the virtual server is called on from the control point, via request from one of the devices in question.

During a step 315, the device in question sends out a request, on the local network, to other devices capable of utilizing the data exchange process that is the subject of the present invention and receives, in return, information about the types of media that the other devices are capable of handling, for example by utilizing the UPnP standard.

During a step 320, each device that receives the request performs a search for at least one media type representing at least one type of physical entity, directly accessible by said device.

During this search, the device carries out a screening according to the remote rights of access associated with each medium. These rights of access (known as DRM, for Digital Rights Management) may comprise refusals to aggregate for media (for example for all the media coming from the signal decoder 157 or through rights on the files stored by the terminal 100), in which case the media server module cannot take account of media for which broadcasting is not authorized.

During this search step, the media server module parses all the media, data files representing physical entities, for example sound and/or image, available in the selected directories of the device.

For preference, for at least one medium utilizing hypertext links, during the search step, pages accessible by the device performing the search are looked for, step 325, and, during the transmission step, a list representing these pages is transmitted.

In a variant, for at least one medium utilizing hypertext links, during the search step, accessible links in a page accessible by these links are looked for.

During a step 330, each device establishes a list or database indexing each medium available. In this virtual database or list, the media are automatically indexed and arranged by physical entity, for example in the following way:
audio-visual media,
still image media,
sound media and
pages available on the computer network, for example Internet, and bookmarked by the user.

The selected media sources are referenced and indexed in a media database. This content and the related information are made available to the world outside each device in the network by means of UPnP requests. Every UPnP-compatible application may connect itself to the media server and ask for any of this media server's content.

The media server provides a database manager by default, even if it could utilize other preexisting database managers.

During a step 335, for each media type in the list thus established, each device transmits to the other devices capable of handling said media type a list representing the media found on said device during the search step. In this case, the media are sorted by the device that carries out the transmission of the list.

During a step 340, each device receives the lists coming from other devices utilizing the data exchange process that is the subject of the present invention.

During a step 345, each device carries out a step of aggregating lists of media found and/or received independent of the device where said media are located, this aggregated list being organized in a tree structure as follows:
firstly, by physical entities represented by said media;
then by media type;
then by centre of interest, genre, date, artist, alphabetical order, the most often or most recently selected media, etc.

In the aggregated list, for each medium, a pointer represents the localization of said medium on the network and an interface capable of handling said medium is associated to each medium. For example, the signal decoder 157 then associates to each medium in the aggregated list, an application interfacing between the format of the medium and the format of the output device to which it is associated, here, the television. For example, the following interfaces are associated with media: MP3, Divix, Codec Microsoft, Codec mpeg 2 (registered trademarks) players. The signal decoder 157 then displays the first level of knots for the aggregated list tree structure, on the television 130.

As part of the aggregation for the list of media, the applications are responsible for showing the user in a unified form services that are in reality delocalized and physically separate.

It is noted that, thanks to these features, each device has access to identification of the media available and with access authorized, without these media having been moved.

In a variant, the devices performing the aggregation of the lists or virtual databases only aggregate the media that they can output. For example, a camera does not aggregate text files. Thus, each medium only displays an aggregated list of the media to which it can give access. In this case, it is the device receiving a list that carries out the screening for the media that it can handle.

During a step 350, the user selects, for at least one device for outputting a medium, a medium represented in the aggregated list, by utilizing the control point.

It is noted that, the media sources being referenced and indexed in a media database, this content and the related information are made available to the world outside each device in the network by means of UPnP requests. Every UPnP-compatible application may connect itself to the media server and ask for any of this media servers content.

For example, during the step 350 of selecting a medium, the user makes the selection by operating a hand-held remote control, step 351.

For example, the hand-held remote control outputs optical signals and radio signals, step 352, in order to control devices possessing suitable receivers for these two types of signal, for example infrared for a television on which you want to output the medium and radio for a computer supplying the medium.

For example, during the step 352, the remote control outputs a request for each device in the remote control's range to provide a response identifying it.

Then, the hand-held remote control displays, on the remote control, three-dimensional images representing devices that have responded, step 353.

In order to select a medium in the aggregated list, the user utilizes the arrow keys and a confirmation key of the remote control, step 354.

In order to select the device for outputting the media, the remote control 170 first sends a request to all the devices capable of communicating with it, in accordance with UPnP standard. In response, all the devices capable of communicating with the remote control 170 send a response identifying them, which is to say indicating the functions of these devices.

When these responses have been received, the remote control 170 displays a three-dimensional shape representative of each device having responded, for example a three-dimensional image of a television with a cathode-ray tube, a three-dimensional image of a flat-screen television, a desktop computer, a portable computer, a signal decoder, a lamp, roller shutters, etc. As FIG. 2A shows, these images are organized in a virtual room resembling the inside of a house or an apartment.

This man-machine interface is adapted to its environment either through configuration by the user or else automatically.

In addition, this man-machine interface carries out an automatic personalization depending on the person utilizing it: an auto-configuration takes place according to the identification of the user. This identification is, for example, given by a secret code or by using a biometric sensor, which makes it possible to assign access limitations to restricted material for certain potential users (for example, children).

If, with the remote control 170, the user selects the media accessible via Internet, by using the right arrow of his or her remote control's keyboard in the list of types of physical entities available, he or she will see, on the output device, for example the television 130, or on the screen of his or her remote control 170, if it has one, a list of the pages of sites directly accessible.

By using the arrows of the remote control's keyboard, the user selects the page in the list of pages and confirms his or her choice with the confirmation key.

Once the user has selected an electronic address in the aggregated list, the page corresponding to said address is displayed and the software application automatically finds all the hypertext links available on the page as well as their position in the page (in X and Y coordinate axes).

By using the remote control's keyboard arrows, the user may choose and select a link from the page.

Thus, in certain embodiments of this invention, the user is provided with an embedded Internet navigator for environments that do not have one. Here the definition of a “navigator” used is that of an application making use of the Internet network and presenting data coming from it in a graphical form, as described earlier.

During a step 360, the user selects a media output device.

During a step 365, the device giving the most direct or quickest access to the selected medium transmits said medium to the device selected to output said medium.

During a step 370, the device selected for outputting the selected medium receives said medium and outputs it.

The media renderer interfaces between the media files and the end output device.

The Renderer module utilizes the principles of exchange between peers, called “peer-to-peer” exchanges in English, in order to exchange media files. It is noted that, in standard architectures, the exchanges between two clients are managed by a server during the whole length of the communication. In the “peer-to-peer” principle, each of the ends knows the other, either through a prior request over a server, which only has this role at the beginning of the session, or because the users have come to an agreement. Each of the two machines is client and server and they have no need of outside help to communicate.

It is noted that:
the “media server” module, which makes it possible for several devices to each display an aggregated list of media available on the network and with authorized access, carries out steps 315 to 345.
the “renderer” module, which utilizes the main data transmission and/or compression standards and drivers of the media available on the network, for example MP3 and divix, is utilized during the step 370 and
the “control point” module, which makes it possible, either by using the remote control 170, or by using the user interfaces of the devices utilized, to select a medium in an aggregated list, and a device for outputting said medium, from among the devices linked to the network, carries out steps 310 and 350 to 360.

The control point module thus makes it possible to select remotely, on the one hand, a device for outputting the information represented by a medium and, on the other hand, a medium to be output by said output device. According to the implementations, the user interface of this module, if it has one, may be a keyboard, a pointing device, a remote control. In other embodiments, without user interface, this module is controlled by a background task automatically starting up a medium at a given time, for example.

FIGS. 4A and 4B show different steps of a particular embodiment of the remote control process that is the object of the third aspect of the present invention, essentially comprising:
a step 400 of setting the remote control's operational parameters,
a step 405 of determining at least one environment parameter for the remote control 170 and
a step 475 of auto-configuring the provisioning of functions and/or media to the remote control's user.

During the parameter-setting step 400, a user considered to be the administrator provides identification data, for example he or she chooses a password or supplies biometric data enabling him or her to be identified, data that will then be required in order to access the administration functions, step 401. The administrator then creates profiles for other users, step 402, and links each user, including him- or herself, to accessible resources (functions and media) on the home network shown in FIG. 1, for example, to television channels, to terminals or to personal data directories available on the network's computers, step 403.

It is noted that each profile comprises environment parameters for the remote control which allow access to functions or media. For example, the administrator decides that, for one user, no media will be available after 11 PM and that this user may only access available media, television channels and radio channels on an identified terminal. For another user, the administrator may give him or her administrator rights identical to his or her rights.

During a step 404, each of the users supplies identification data (password or biometric data, for example) that will enable him or her to be identified each time that he or she uses the remote control 170, and ergonomics for presenting information via the remote control. These ergonomics relate, for example, to the display definition, the character font(s) used, the format of displayed information, a hierarchy of display criteria (for example, by authors name, by title, by date last accessed, by frequency of access, by equipment and directory accessible on the home network).

During the step 405 of determining at least one environment parameter for the remote control, the person using the remote control is ascertained, step 410. The determination of the person using the remote control may be performed through the display, on the remote control or on a screen of a computer terminal or on a television screen, of a request for a secret code (or password), step 411, the entry of the secret code via the remote control's keyboard, step 412, and the checking of the secret code against a secret code memorized in the remote control during installation or re-programming, step 413.

The determination of the person using the remote control may also be performed through biometric measurement, step 414, and comparison against biometric data stored in the remote control's memory, step 415. The biometric measurement is for preference performed on the user's hand, for example a finger.

The determination of the person using the remote control may also be performed through recognition of the user's voice, step 416, the remote control then being equipped with a microphone (not shown).

The determination of the person using the remote control may also be performed through recognition of a gesture, step 417, for example a movement, the remote control then being equipped with a means of determining movement, for example a gyroscope (not shown).

The determination of the person using the remote control may also be performed through recognition of an object, step 418, for example a memory card or a key that can be plugged in, for example to a USB port, on the remote control, or through communicating, at short distance, with a portable emitter, for example a mobile telephone utilizing the Bluetooth standard or the Wifi standard or an electronic tag, for example utilizing the RFID standard (acronym for radio frequency identification).

During the step 405 of determining at least one environment parameter for the remote control, the equipment capable of being remotely controlled by the remote control is determined, step 420. The determination of this equipment may be performed by utilizing a communication in accordance with the UpnP standard (acronym for Universal Plug and Play), step 421.

The determination of this equipment may be performed by utilizing a localization in space, also called geo-localization, step 422, for example by processing signals received from transmitter terminals arranged in the building where the remote control is, or by processing signals coming from satellites and/or ground transmitters, for example geo-localization processing known under the name of differential global positioning system. Once the remote control's location has been determined, the equipment found in the remote control's range is searched for, in memory.

During the step 405 of determining at least one environment parameter for the remote control, the media capable of being remotely controlled by the remote control are determined, step 425. The determination of these media may be performed via request to one of the devices communicating with the remote control, step 426, said device carrying out a search of the media to which it allows a direct access and the media available through other devices not communicating directly with the remote control. A list of these media, organized for example by media type, is then displayed, either on a screen of the remote control, or on a screen of one of the network's devices, for example a screen of a computer terminal or a television, the remote control making it possible to navigate within this organized list, for example by using the arrow, return and confirmation buttons.

During the step 405 of determining at least one environment parameter for the remote control, the time is ascertained, step 430. The determination of the time may be performed by reference to a clock internal to the remote control, step 431, or via request to one of the devices communicating with the remote control, step 432.

During the step 405 of determining at least one environment parameter for the remote control, the functions available for equipment capable of being remotely controlled by the remote control are determined, step 435. The determination of these functions may be performed by utilizing a communication in accordance with the UpnP standard, step 436.

During the step 475 of auto-configuring the provisioning of functions or media to the user of the remote control 170, the functions and/or the media to which access is authorized and/or available are displayed, step 480, and/or activated, step 490, according to each environment parameter determined during the step 405.

Thus, depending on the person using the remote control, his or her profile, the equipment capable of being remotely controlled, the media available, the position in space of equipment capable of being remotely controlled, the time and the availability of functions for equipment communicating with the remote control, the following is/are displayed and made available to the user:
media and/or
functions of equipment available on the home network and capable of being remotely controlled by the remote control 170.

The display itself may be personalized depending of environment parameters indicated above, for example depending on the person using the remote control and the preferences that he or she indicated during a parameter-setting step.

For example, the organization of authorized and available media may utilize data concerning media usage by the identified user, for example by listing first the media that this user of the remote control has used most or has used the most recently.

It is understood that, thanks to the utilization of the remote control process that is the subject of the present invention, use of the remote control 170 presents optimized ergonomics and/or protection for the user.

For example, depending on the person using it and/or the time, the remote control limits the television channels that can be accessed or limits access to media present on a computer network.

According to another example, depending on the equipment in the remote control's range, different media or different functions are proposed to the user.

As a result, the user has a configuration for the remote control that is appropriate for him or her according to at least one environment parameter for the remote control.

1-28. (canceled)

29. Process of data exchange between devices linked to a network, that comprises:
a step of searching, by each of at least two devices, for at least one media type representing at least one type of physical entity, directly accessible by said device,
a step of transmitting, by each device having carried out said search step to at least one other device capable of handling said media type, a list representing media found on said device during the search step and
a step of aggregating, by each device having carried out said search step, lists of media found and/or received independent of the device where said media are located.

30. Process according to claim 29, wherein during the aggregation step, the aggregated lists are organized by physical entity.

31. Process according to claim 29 wherein, during the aggregation step, the aggregated lists are organized by media type.

32. Process according to claim 29 wherein, during the search step, media subject to a broadcast limitation or ban are not taken into account.

33. Process according to claim 29 wherein, during the aggregation step the aggregated list comprises, for each medium, a pointer representing the localization of said medium on the network.

34. Process according to claim 29 wherein, during the aggregation step, the aggregated list comprises, for each medium, an interface capable of handling said medium.

35. according to claim 29 that comprises a step of selecting a media output device.

36. Process according to claim 29 that comprises a step of selecting, for at least one media output device, a medium represented in the aggregated list.

37. Process according to claim 36, wherein said step of selecting a medium comprises a step of selection by a hand-held remote control.

38. Process according to claim 37, wherein during the step of selection via a hand-held remote control, optical signals and radio signals are output by said remote control.

39. Process according to claim 37 wherein, in the course of the step of selection via a hand-held remote control, three-dimensional images representing devices capable of outputting at least one media type are displayed, on said remote control.

40. Process according to claim 30 wherein, during the step of selection via a hand-held remote control, a request is output for each device in the remote control's range to provide a response identifying it.

41. Process according to claim 30 wherein, during the step of selection via a hand-held remote control, arrow keys and a confirmation key are utilized.

42. Process according to claim 30 wherein, following the step of selecting a medium, the device giving the most direct access to the selected medium transmits said medium to the device selected to output said medium.

43. Device for exchanging data between devices linked to a network, that comprises, in at least two of said devices:
a means of searching for at least one media type representing at least one type of physical entity, directly accessible by said device;
a means of transmitting, by at least one other device capable of handling said media type, a list representing media found on said device during the search means and
a means of aggregating lists of media found and/or received independent of the device where said media are located.

44. Device according to claim 43, wherein the aggregation means is adapted so that the aggregated lists are organized by physical entity.

45. Device according to claim 43 wherein the aggregation means is adapted so that the aggregated lists are organized by media type.

46. Device according to claim 43 wherein the search means is adapted to not take into account media subject to a broadcast limitation or ban.

47. Device according to claim 43 wherein the aggregation means is adapted so that the aggregated list comprises, for each medium, a pointer which represents the localization of said medium on the network.

48. Device according to claim 43 wherein the aggregation means is adapted so that the aggregated list comprises, for each medium, an interface capable of handling said medium.

49. Device according to claim 43 that comprises a means of selecting a medium represented in the aggregated list.

50. Device according to claim 43 that comprises a means of selecting a device for outputting a medium.

51. Device according to claim 50, wherein said means of selecting a medium comprises a hand-held remote control.

52. Device according to claim 51, wherein said hand-held remote control comprises an optical signal emitter and a radio signal emitter.

53. Device according to claim 51 wherein the hand-held remote control is adapted to display three-dimensional images representing devices capable of outputting at least one media type.

54. Device according to claim 51 wherein the hand-held remote control is adapted to output a request for each device in the remote control's range to provide a response identifying it.

55. Device according to claim 51 wherein at least one device is adapted so that the selection of a medium utilizes arrow keys and a confirmation key.

56. Device according to claim 43 wherein, where the selection of a medium involves a medium for which the device gives the most direct access to the selected medium, the means of transmission is adapted to transmit said medium to the device selected to output said medium.

57. Process according to claim 37, that comprises:
a step of determining at least one environment parameter for the remote control and
a step of auto-configuring the provisioning of functions and/or media to the remote control's user.

58. Process according to claim 57 wherein, in the course of the step determining at least one environment parameter for the remote control, the person using the remote control is ascertained.

59. Process according to claim 57 wherein, in the course of the step determining at least one environment parameter for the remote control, the equipment capable of being remotely controlled is ascertained.

60. Process according to claim 57 wherein, in the course of the step determining at least one environment parameter for the remote control, the media available are ascertained.

61. Process according to claim 57 wherein, in the course of the step determining at least one environment parameter for the remote control, the position in space of the equipment capable of being remotely controlled is ascertained.

62. Process according to claim 57 wherein, in the course of the step determining at least one environment parameter for the remote control, the time is ascertained.

63. Process according to claim 57 wherein, in the course of the step determining at least one environment parameter for the remote control, the availability of functions for equipment utilizing a communications protocol with the remote control is ascertained.

64. Process according to claim 57 wherein, in the course of the step of auto-configuring, the provisioning of functions or media to the remote control's user, the functions and/or the media to which access is authorized and/or available are displayed and/or activated, according to each environment parameter determined during the step of determining at least one environment parameter for the remote control.

65. Device according to claim 51, that comprises:
a means of determining at least one environment parameter for the remote control and
a means of auto-configuring the provisioning of functions and/or media to the remote control's user.
